(19) United States
(12) Patent Application Publication
(10) Pub. No.: US 2005/0251304 A1
(43) Pub. Date: Nov. 10, 2005

(54) Device and method for performing both local and remote vehicle diagnostics

(76) Inventors: Pasquale Cancellara, San Mauro Torinese (IT); Orlando Varalda, Volpiano (IT)

Correspondence Address: STETINA BRUNDA GARRED & BRUCKER, 75 ENTERPRISE, SUITE 250, ALISO VIEJO, CA, 92656, US

(21) Appl. No.: 11/119,982

(22) Filed: May 2, 2005

(30) Foreign Application Priority Data
May 3, 2004 (IT) MI2004A000880

(51) Int. Cl. G06F 7/00; G01M 17/00

(52) U.S. Cl. 701/33; 701/29

(57) ABSTRACT

This invention relates to a device for performing both local and remote vehicle diagnostics, that is scaleable to suit the different configurations and comprises a vehicle communication unit (ECI), that acts as an intelligent interface to a vehicle to which it is connected, and that is capable of functioning in an active mode, in which it performs autonomous vehicle diagnostics and communication functions, and in a passive mode via an externally-controlled bidirectional connection.

### BACKGROUND OF THE INVENTION

1. Field of the Invention

This invention relates to a device and method for performing both local and remote vehicle diagnostics.

2. Description of the Prior Art

At present, vehicle diagnosis is performed in specially equipped service bays where the vehicle is connected to a local diagnostics unit that measures certain characteristic parameters, especially those that are assumed to be incorrect in the event of a vehicle malfunction.

The latest technology consists of outfitting service bays with equipment that is capable of establishing a bidirectional communication with one or more of the in-vehicle electronic control modules, and of downloading data and parameters stored in the control module(s) with the vehicle running (for example data concerning faults that have occurred), and also of transmitting data and parameters, for example as regards the calibration of on-board instruments or vehicle configurations, to such control modules.

In any case, diagnostics operations are performed locally.

New problems are now arising in connection with the need to extend the possibility of communicating with repair shops that are not specifically authorized, possibly in remote locations, in order to remotely diagnosing problems. This requires the use of more flexible equipment in order to provide a centralized diagnostics service, in which the diagnostics tool can be remotely controlled, possibly to assist technicians at a specific workshop carrying out operations on the vehicle as it is being driven down the road.

In view of these new requirements, service bay technicians need a set of simple, lightweight and flexible tools. The equipment must have a low financial impact on the repair shop, and the cost must, in any case, be proportional to the use. It must be possible to share the information that is acquired.

### SUMMARY OF THE INVENTION

Therefore the purpose of this invention is to solve the problems described above with a device and method for performing both local and remote vehicle diagnostics that is particularly efficient, due to the fact that it is modular and scaleable, low-priced and easy to use.

As regards the hardware, the device complements the existing system, which may be integrated with low-cost external modules; it increases flexibility by using wireless technology; consumer products can be used to replace or supplement older hardware.

As far as the software is concerned, the system is modular and characterized by the fact that: it complements the existing system; it can be installed on consumer products; it manages external modules; it manages on-board modules; it uses wireless technology; it can be updated remotely also via internet; in case of large-scale systems it can be integrated with “server” type functions.

The system is thus flexible and (re)configurable according to the specific requirements; it comprises a network of modules in which the in-vehicle electronics constitute one of the modules.

The workstations are generally equipped with “terminals” for diagnosis and “especially” to access information in real-time.

The subject of the invention is a device for performing both local and remote vehicle diagnostics, characterized by the fact that it is scaleable to suit the different configurations and comprises a vehicle communication unit, that acts as an intelligent interface to a vehicle to which it is connected, and comprising: means for enabling an active functioning mode, in which it performs autonomous vehicle diagnostics and communication functions, and means for enabling a passive functioning mode via an externally-requested bidirectional connection; means of establishing an external bidirectional connection, in order to create such scaleable configurations comprising: a first “local” connection level, to a local processing system; a second “passive remote” connection level, via a local processing system to an external network and a remote processing unit; a third “active remote” connection level directly to an external network and a remote processing unit.

Another subject of the invention is also a method for performing both local and remote vehicle diagnostics, characterized by the fact that it is based on the use of a vehicle communication unit as described above, that is capable of operating in the active and passive modes, in which such vehicle communication unit is normally in the active mode, and moves to the passive mode on receiving a request from the outside, and that in such vehicle communication unit it comprises the following steps:
an initialization step followed by a standby condition in the active mode, until one of the following steps occurs;
a communication step in which an event is signalled to the outside;
a send step in which a status message is sent at intervals to the outside;
a transition step to the passive mode, upon receiving a command from the outside, to perform an externally-requested operation, and return to the active mode;
a performing step in which vehicle diagnostics are performed at intervals and the relative data are sent to the outside.

In particular this invention relates to a device and method for performing both local and remote vehicle diagnostics, as described more fully in the claims, which are an integral part of this description.

### BRIEF DESCRIPTION OF THE DRAWINGS

The purposes and advantages of this invention will become clear from the following detailed description of a preferred embodiment (and the relative alternative forms of embodiment) and the drawings that are attached hereto, which are merely illustrative and not limitative, in which:

FIG. 1 is a general view of the device according to this invention;

FIG. 2 is a block diagram of the vehicle communication unit, which is part of the device;

FIG. 3 is a block diagram of the program modules of the device;

FIG. 4 is a flow chart of the part of the program that is resident in the vehicle communication unit.

### DESCRIPTION OF THE PREFERRED EMBODIMENT

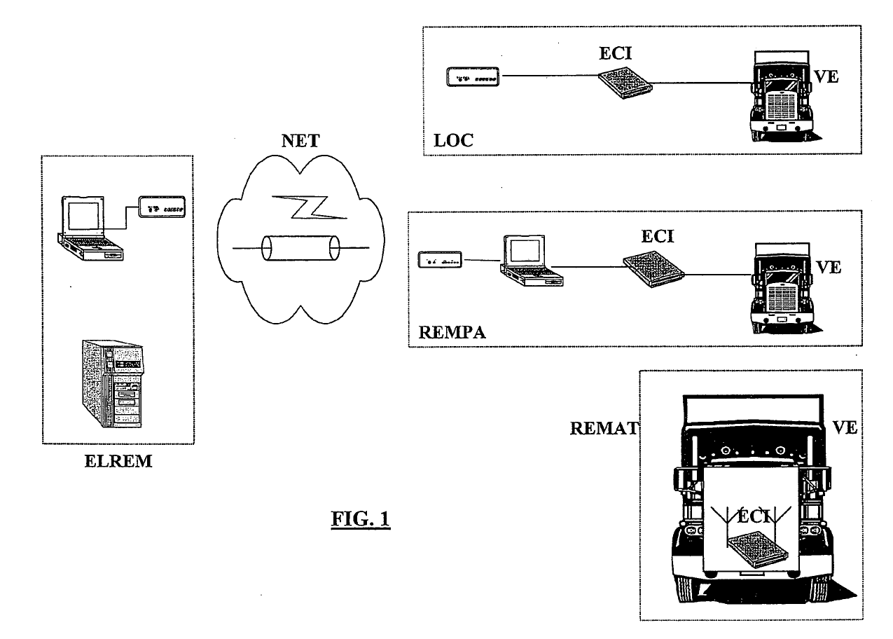

With reference to FIG. 1, the system is modular and scaleable, and is based on a vehicle communication unit ECI, that comprises an intelligent bidirectional interface to perform the diagnostics/communication functions as described below. A number of configurations are possible in which the ECI represents the connection “gateway” towards the vehicle VE, while the configurations to the outside are scaleable to suit the different possible connection levels.

A first “local” connection level LOC, in which the ECI is an interface, possibly equipped with a display, for example a hand-held display, connected for example via a wireless link (e.g. Bluetooth) to a local PC situated for example in the service bay. In this configuration ECI can avoid connection to a local PC, as it can integrate all the functionalities necessary to the purpose.

A second “remote passive” connection level REMPA, in which the ECI is connected to a local PC that is also a gateway towards an external network NET via an Internet or Ethernet or Wireless (Bluetooth) connection to a remote client or server PC-type processing unit ELREM.

A third “remote active” connection level REMAT in which the ECI integrates the connection to the remote network in place of the local PC, via two kinds of wireless links: a remote connection to the network NET, for example via the GPRS system, and a local connection, for example Bluetooth, to a local PC. In this case the ECI is installed inside the vehicle.

When interfacing the vehicle/system, the ECI dialogues with the in-vehicle electronic control modules.

According to the specific configuration, the data (diagnostic or other data) can be displayed directly on a small LCD screen on the actual instrument or using a PC for example connected via LAN, USB, RS232, wireless technology, GSM, . . . .

According to the specific configuration, the ECI can be connected to the in-vehicle control module(s) by means of dedicated adapters that supply the necessary power in order to operate it and the dedicated communication lines. Through these adapters diagnostics can be performed on different interfaces using different diagnostics connectors (for example the conventional Packard, 30-pole, EOBD, . . . )

In particular the ECI performs the following functions:
provides “basic” diagnostic information;
enables communication, as a universal “adapter” (gateway) between the in-vehicle electronic systems and a normal local PC;
enables remote monitoring of vehicle functions;
enables dynamic recording of vehicle functions;
enables updating of software via PC or other system with a wired or wireless or USB or RS232 connection;
can act as a gateway to the vehicle for queries from the outside regarding vehicle functions;
can automatically send data to the outside, for example data regarding a vehicle malfunction, so that the technician is informed of any problems in advance and can act more promptly, or effect a predictive diagnosis, to reduce vehicle down times; predictive diagnosis or statistical analysis data;
an integrate the interface function of the local PC to the outside;
can also integrate a global positioning system (GPS);

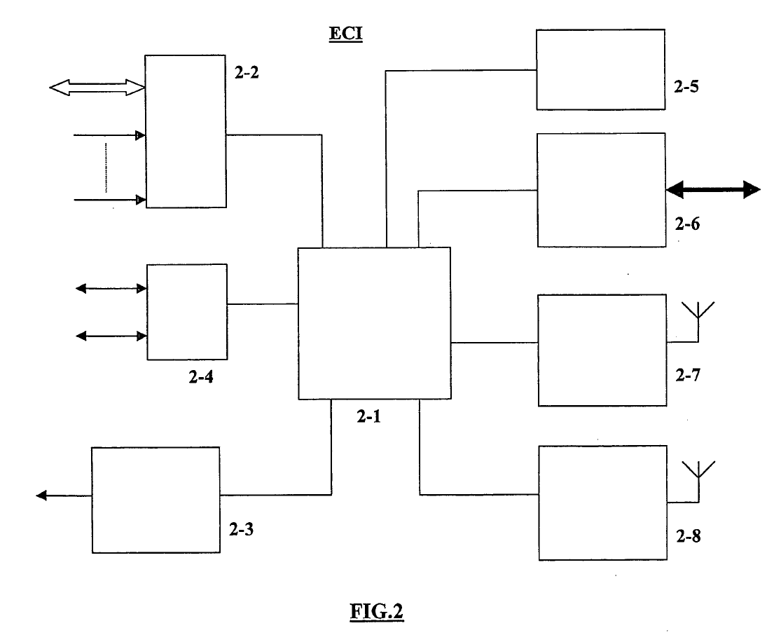

With reference to FIG. 2, the ECI has a modular hardware structure, which makes several configurations possible:
2-1 indicates a processing unit, for example incorporating a microprocessor, that manages all the functions, and the bidirectional connections from and to the vehicle and from and to the outside;
2-2 indicates an interface to the in-vehicle networks, mainly consisting of the CAN bus, or the various K serial lines. As known the CAN bus carries data between the various in-vehicle electronic components according to a conventional protocol, while the various K serial lines consist of point-to-point wires to single control modules, for example to pick up additional data that are not yet available on the CAN bus;
2-3 indicates an interface to telematics devices used to deliver services to fleets: they obtain important data regarding the fleet that are filtered and delivered via an external connection, for example fuel consumption data;
2-4 indicates a bidirectional interface for communication from or to in-vehicle devices, relating to analog and digital signals;
2-5 indicates an interface unit to the driver and integrating display and data input functions;
2-6 indicates a module for communication to local external devices, such as client PC, PDA, via wired connections, for example a USB, RS232 interface, or using wireless technology, for example Bluetooth, WiFi, etc . . . ;
2-7 indicates a module for communication with the remote external network, for example either wireless (GSM, GPRS, UMTS, CDMA), or via Internet, Ethernet;
2-8 indicates a global positioning system module (GPS).

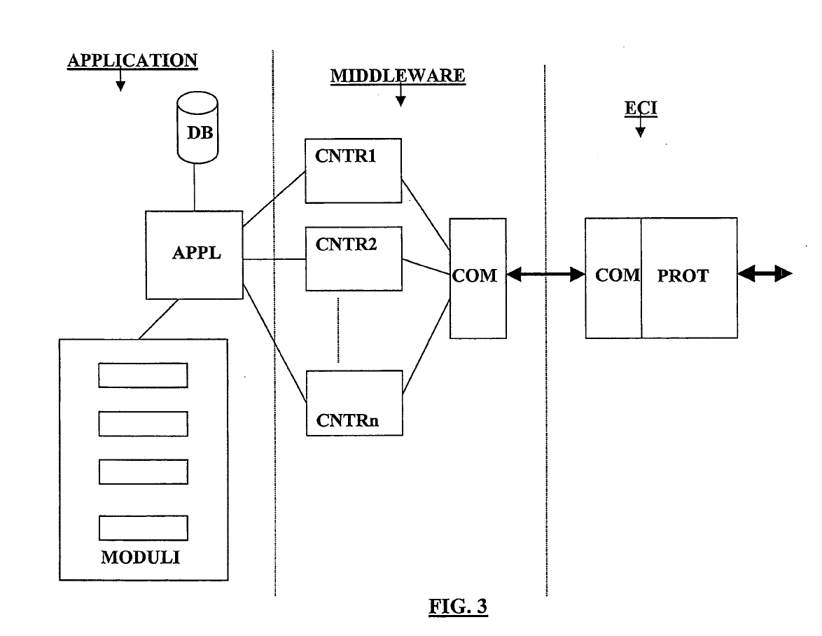

With reference to FIG. 3, the entire system is based on a modular software architecture that consists of three main parts:
a part that is resident in the ECI, consisting of a vehicle protocol management module PROT, that dialogues with the in-vehicle electronics networks, and a module COM that manages communications to the outside. This part is capable of operating in two modes: in Slave mode, in which the ECI mainly acts as a passive gateway for the supply of data to the outside, or for the input of data from the outside; and in Master mode, in which the ECI performs an active diagnostics function;
a middleware part (business layer) that is resident in a client PC, consisting of a communication module COM that dialogues with the corresponding COM module in the ECI, and a number of modules CENTR1, CENTR2, . . . CENTRn, one for each one of the in-vehicle control modules, that perform remote vehicle diagnostics functions and communicate with the relative in-vehicle control modules, via the ECI;
an application layer part, that is resident in a client PC or in a network server, consisting of an application APPL that is divided into various modules, supported by a database DB.

The programming technology that is used is of the known object-based type, for example Microsoft® COM (Component Object Model); the object-based programming languages used are of the known type, for example C++ for the part resident in the ECI and the middleware, or ASP, Visual Basic, Java for the application part.

Dividing the software into modules makes it more flexible and more readily adapted to suit the specific requirements, as any modifications, additions or eliminations concerning one module do not affect the others.

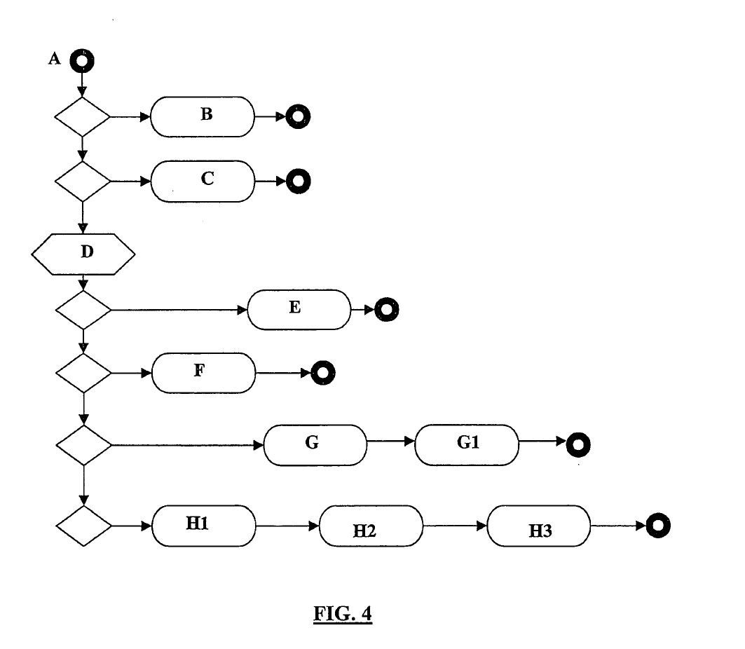

With reference to FIG. 4 the operational flow chart of the program resident in the ECI is now described. This is also useful for describing the method of vehicle diagnostics according to this invention.

Starting from an initial phase A, if necessary, the program moves to a configuration phase B, that may only be activated at the initial start-up, even before connecting the system for use, in order to configure the ECI correctly according to the specific use, and introduce the parameters or parts of the program to be used. Then it returns to point A.

Else the ECI moves to a subsequent Validation phase C, for example when the unit is switched on after connection or batteries insertion, in which if necessary it establishes the correct connection with the in-vehicle electronics. Then it returns to point A.

Else, having completed the initial phases, or if these are not necessary, the ECI moves to a standby condition D (IDLE), in which it remains until one of the subsequent phases is activated.

When an event occurs that is programmed to be signalled to the outside, for example an event belonging to a list of events in a memory table periodically scanned, such as an anti-theft alarm, the ECI moves to phase E in which it sends a corresponding signal (alarm) to the outside, and then returns to point A and the IDLE condition D.

At fixed intervals, (e.g. every 5 minutes), or after a fixed number of kilometers (e.g. every 1000 Km), or at a specific request from the outside, the ECI moves to phase F in which it sends a status message to the outside, containing for example some parameters obtained by the in-vehicle electronics network with the vehicle running, and stored in the ECI. Then it returns to point A and the IDLE condition D.

When it receives a specific request from the outside, the ECI moves to phase G in which it performs a specific externally-requested operation, such as a (re)programming of the vehicle control modules or of ECI itself, a (re)configuration of the vehicle parameters in the control modules, a display of data, a parameter acquisition, a calibration, etc . . . . Then it returns to point A and the IDLE condition D.

More in details, in the case for example of (re)programming, the following steps occur:
ECI receives from the outside a reprogramming request, through a message indicating the module to be updated;
ECI goes to an updating state G1 in which:
It checks the existence of the conditions allowing performing updating, i.e. security checking, stopped vehicle conditions checking, etc.;
It performs connection to the external server (i.e. FTP type);
It performs downloading of the software module;
It performs reprogramming of the internal memory of the module;
At the end it sends a confirmation message of performed updating, then it goes back to A and then to IDLE.

At fixed intervals, (e.g. every 5 minutes), or after a fixed number of kilometers (e.g. every 1000 Km), or at a specific request from the outside, the ECI moves to phase H1 in which it launches a diagnostics cycle.
First of all (phase H1) it enters a loop in which it reads and acquires data and parameters from the in-vehicle control modules, via the various internal buses (CAN; K . . . )

Next, in phase H2, it subjects the parameters that have been obtained to a diagnostic analysis, and establishes whether certain parameters must be communicated to the outside, for example if they are outside the normal range or different to those obtained previously, and prepares the data to be transmitted.

In phase H3 it transmits the data to the outside. Then it returns to point A and the IDLE condition D.

The method for organizing transmission messages can be of any known type, for example packet or frame organized, and depends also from the type of known communication protocol used.

The method for performing remote vehicle diagnostics according to this invention is thus based on the presence of the vehicle communication unit ECI, that is capable of functioning in two modes: active and passive.

More specifically, the ECI is normally in the active mode, and moves to the passive mode at a request from the outside.

After the initialization phases (B, C), the ECI moves to the active mode in the standby condition (IDLE), until one of the specific phases occurs:
signalling of an event to the outside;
sending of a status message at intervals to the outside;
transition to the passive mode, upon receiving a command from the outside, to perform an externally-controlled operation, and return to the active mode;
performance of vehicle diagnostics at intervals with the relative data being sent to the outside.

In the passive mode, as Slave, the ECI is controlled from the outside and mainly acts as a gateway for the supply of data to the outside, or for the input of data from the outside (see phase G); in the active mode, as Master, the ECI performs an autonomous function, which mainly consists of diagnostics (see phases E, F, H).

This invention can be implemented advantageously in a computer program comprising program code means for performing one or more steps of such method, when such program is run on a computer. For this reason the patent shall also cover such computer program and the computer-readable medium that comprises a recorded message, such computer-readable medium comprising the program code means for performing one or more steps of such method, when such program is run on a computer.

It will be apparent to the person skilled in the art that other alternative and equivalent embodiments of the invention can be conceived and reduced to practice without departing from the true spirit of the invention.

From the description set forth above it will be possible for the person skilled in the art to embody the invention without introducing any further construction or programming details.

1. A device for performing both local and remote vehicle diagnostics, wherein it is scaleable to suit the different configurations and comprises a vehicle communication unit, that acts as an intelligent interface to a vehicle to which it is connected, comprising:
an active functioning mode enabler, in which it performs autonomous vehicle diagnostics and communication functions, and a passive functioning mode enabler via an externally-requested bidirectional connection;
an external bidirectional connection enabler, in order to create said scaleable configurations comprising: a first “local” connection level, to a local processing system; a second “remote passive” connection level, via a local processing system to an external network and a remote processing unit; a third “remote active” connection level directly to an external network and a remote processing unit.

2. A device for performing both local and remote vehicle diagnostics according to claim 1, wherein said active or passive functioning mode enabler, and said external bidirectional connection enabler comprise:
a processing unit, that manages said active and passive operating modes and said bidirectional connections from and to the vehicle and from and to the outside;
one or more interfaces for the two-way exchange of information and parameters from and to in-vehicle networks;
an interface to the driver, with display and data input functions;
a module for communication to said local processing system;
a module for communication to said external network;
a global positioning system module.

3. A method for performing both local and remote vehicle diagnostics, wherein it uses a vehicle communication unit according to claim 1 or 2, that is capable of operation in the active and passive modes, in which said vehicle communication unit is normally in the active mode, and moves to the passive mode upon receiving a request from the outside, and wherein in said vehicle communication unit it comprises the following steps:
an initialization phase, followed by a standby condition in the active mode, until one of the following phases occurs;
a communication step in which an event is signalled to the outside;
a send step in which a status message is sent at intervals to the outside;
a transition step to the passive mode, upon receiving a command from the outside, to perform an externally-requested operation, and return to the active mode;
a performing step in which vehicle diagnostics are performed at intervals and the relative data are sent to the outside.

4. A method for performing both local and remote vehicle diagnostics according to claim 3, wherein said transition step to the passive mode comprises one or more of the steps of: (re)programming of vehicle control modules or of said vehicle communication unit; (re)configuration of vehicle parameters in the control modules; display of data; parameter acquisition; calibration.

5. A method for performing both local and remote vehicle diagnostics according to claim 4, wherein said step of (re)programming of vehicle control modules comprises:
receiving from the outside a reprogramming request;
going to an updating state comprising:
checking the existence of the conditions allowing performing updating;
performing connection to the outside;
downloading of software module for the updating;
reprogramming with said software module;
sending to the outside a confirmation message of performed updating.

6. Computer program comprising program code means for performing the steps in claims 3 to 5, when said program is run on a computer, wherein it is modular, and basically comprises:
a part that is resident in said vehicle communication unit, comprising a vehicle protocol management module, that dialogues with the in-vehicle electronics networks, and a module that manages communications to the outside in order to implement said active and passive operating modes;
a middleware part (business layer) that is resident in an external processing system, comprising a communication module that dialogues with the corresponding module in said vehicle communication unit, and a number of modules, that perform remote vehicle diagnostics functions and communicate with the relative in-vehicle control modules;
an application layer part, that is resident in an external processing system, comprising an application that is divided into various modules, supported by a database.

7. Computer-readable medium comprising a recorded program, said computer-readable medium comprising the program code means in order to perform the steps in claims 3 to 5, when said program is run on a computer, wherein said program is modular, and basically comprises:
a part that is resident in said vehicle communication unit, comprising a vehicle protocol management module, that dialogues with the in-vehicle electronics networks, and a module that manages communications to the outside in order to implement said active and passive operating modes;
a middleware part (business layer) that is resident in an external processing system, comprising a communication module that dialogues with the corresponding module (COM) in said vehicle communication unit, and a number of modules, that perform remote vehicle diagnostics functions and communicate with the relative in-vehicle control modules;
an application layer part, that is resident in an external processing system, comprising an application that is divided into various modules, supported by a database.
